(19) United States
(12) Patent Application Publication
(10) Pub. No.: US 2011/0289588 A1
(43) Pub. Date: Nov. 24, 2011

(54) Unification of security monitoring and IT-GRC

(76) Inventors: Anupam Sahai, Santa Clara, CA (US); Chandrasekhar Bilugu, Santa Clara, CA (US); Sanjay Debnath, Santa Clara, CA (US); Sudhakar Damacherla, Santa Clara, CA (US); Dharma Nayak, Santa Clara, CA (US); Araf Karsh, Santa Clara, CA (US); Sreenivas Bilugu, Santa Clara, CA (US)

(21) Appl. No.: 13/112,240

(22) Filed: May 20, 2011

Related U.S. Application Data
(60) Provisional application No. 61/346,778, filed on May 20, 2010.
(60) Provisional application No. 61/346,782, filed on May 20, 2010.

(51) Int. Cl. G06F 11/00

(52) U.S. Cl. 726/25

(57) ABSTRACT

A method of effective information governance and risk management includes Integrating security monitoring and compliance management application silos. The integrated silos are delivered through a cloud based infrastructure.

### CROSS-REFERENCE TO RELATED APPLICATIONS

This application claims the benefit of U.S. Ser. No. 61/346,778 filed May 20, 2010, and U.S. Ser. No. 61/346,782 filed May 2010, both of which applications are fully incorporated herein by reference.

### BACKGROUND OF THE INVENTION

1. Field of the Invention

The present invention relates to cloud computing, and more particularly to the unification of security monitoring and IT-GRC.

2. Description of the Related Art

Concerns towards effective information governance and risk management strengthen from the increasing trend in cyber-security and data breaches, the average cost per breach being US$202. As per a recent survey in 2009, Corporations lost $1 trillion worldwide as a result of data loss, both malicious and accidental. The impact of the breach leaves no segment untouched: retail, technology firms, medical industry and even defense.

An innovative tool, IT GRC management software, has emerged to address some of these problems. The “G” in GRC—governance—connects security management practices with enterprise wide governance and overall risk that goes beyond information technology. However the IT-GRC tools are not integrated with the security monitoring tools in the enterprise leading to disparate views assessment of the enterprise risk, leading to risk and liability exposure which can lead to catastrophic results.

### SUMMARY OF THE INVENTION

An object of the present invention is to provide systems and methods to to integrate and automate GRC.

Another object of the present invention is to provide systems and methods to integrate and automate GRC tools by combining compliance workflow with control assessment automation and security monitoring.

### BRIEF DESCRIPTION OF THE DRAWINGS

FIG. 1 is the Data Breach Investigations Report from Verizon Business.

FIG. 2 is a diagram illustrating various security attacks.

FIG. 3 illustrates a PDCA model.

FIG. 4 illustrates one embodiment of a backend infrastructure that can scale up on demand as the customer demand grows and this can be done dynamically on the fly.

FIG. 5 illustrates one embodiment of a layered functional diagram.

FIG. 6 illustrates a cloud architecture.

FIG. 7 illustrates mapping to the architecture.

FIG. 8 illustrates a 6 dimensional data normalization.

FIGS. 9a-9l illustrate examples of multidimensional data normalization.

FIG. 10 illustrates various examples of submodels revolving around the risk determination algorithm.

FIGS. 11a and 11b illustrate how the contexts are mapped to evens.

FIG. 12 depicts business content with risk classification.

FIG. 13 illustrates subcontexts divided to identify assets.

FIG. 14 illustrates a multi-dimensional context mapping for events.

FIG. 15 illustrates an event showing P2P traffic on the network.

FIGS. 16a-16b illustrate how different types of threats are profile based.

FIG. 17 illustrates a quantitative risk model.

### DETAILED DESCRIPTION OF THE PREFERRED EMBODIMENTS

The next generation solution needs to integrate and automate GRC tool needs to combine compliance workflow with control assessment automation and security monitoring. The present invention is a comprehensive solution covering enterprise security, governance, risk management, audit, and compliance needs through a unified solution offering delivered via Software as a service.

From a stage when organizations were blissfully ignorant of the impact of information security infringements, more focused on finding automated business solutions through information technology, today the awareness is growing and organizations are investing heavily on IT security solutions. With a number of solutions, products and platforms that are available in the market, the security products have evolved over a period of time—typically as any software solution that have emerged in the enterprise segment—pieces of solutions that address or focus on some specific elements of the problem. Organizations were left to themselves in managing all the technical and policy controls that they implemented for risk reduction and compliance.

Concerns towards effective information governance and risk management strengthen from the increasing trend in cyber-security and data breaches. The press today—online and traditional print media, has plenty of stories of such incidents. Surveys and research studies keep reinforcing the lack of security, or where measures exist, their lack of effectiveness to counter the security threats; Cyber threat and cyber security are hot topics today.

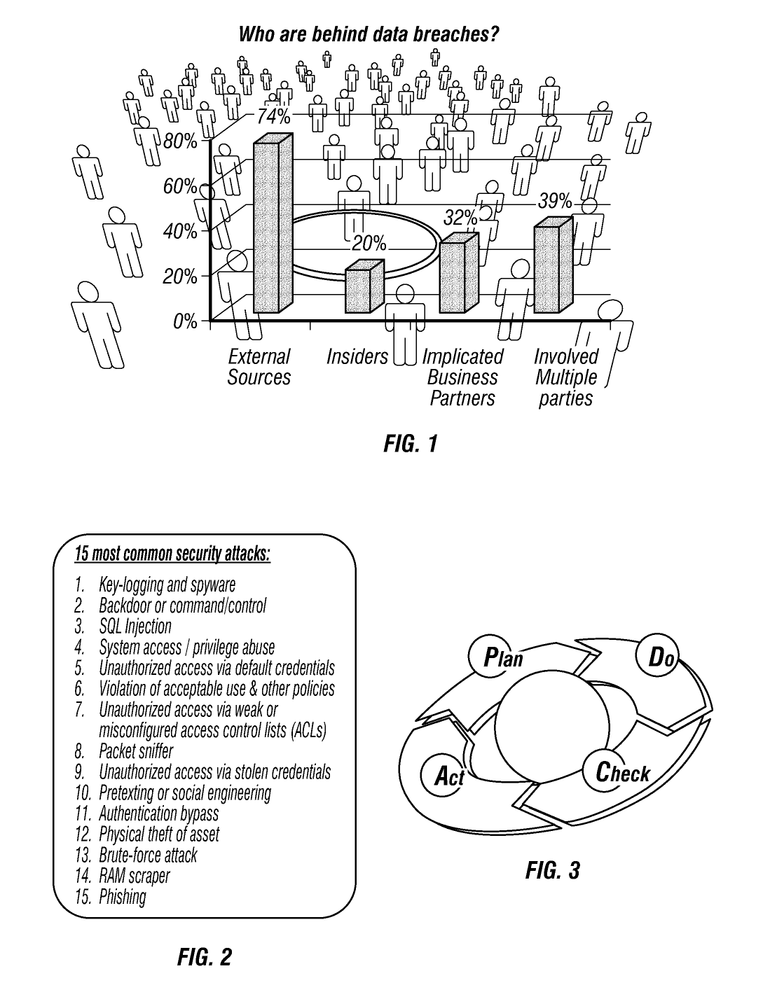

The 2009 Data Breach Investigations Report from Verizon Business for instance (FIG. 1) reports “90 confirmed breaches within our 2008 caseload encompass an astounding 285 million compromised records”. In further analyzing as to who were behind the data breaches, the report highlights the incidence of ‘external sources’ behind the data breaches as the highest.

The report also highlights that the highest cause of the breach is due to ‘significant errors’-67%. The report adds, “99.9% of the records were compromised from data resident on internal servers and applications”.

The costs of breaches are enormous. Costs from the largest computer data breach in corporate history at TJX, in which more than 45 million customer Credit and Debit card numbers were stolen was estimated at US$256 million. Gartner analysts estimate that the cost of sensitive data break will increase 20 percent per year through 2009. “When you consider that the average cost per record breached is US$202, it becomes clear just how much we all stand to lose”.

The most affected are the retail industry (35%), followed by technology firms (20%), banking and financial industry (20%), medical industry (15%) and the defense industry (10%) What these figures signify is the truth—‘better the security infrastructure lower is the percentage of breaches’. Overall, only 5% of the companies resort to security monitoring. The majority (55%) has absolutely no mechanisms for monitoring, and the rest 40% conveniently outsourced the IT security monitoring functions to managed services providers.

The 15 most common security attacks are shown (FIG. 2). On top of the increase in threat levels and dramatic rise in regulatory activity, complexity of information technology also goes up. Companies now have to deal with complex, networked systems that perform critical business functions and might have components deployed inside the enterprise, on partner networks and also on private and public cloud infrastructure. More and more assets also use virtualization technology to achieve cost savings as well as other benefits such as energy savings and improved infrastructure resiliency.

IT-GRC does not stop threats; it helps people manage “the whole process” of IT security, compliance, and risk management through policy guidelines and implementation. Complying with a regulatory framework, as a first step, reduces the risk significantly, as these regulations or standards are the collective wisdom of specialists in the society and thereby helps reduce the risk exposure through adoption of the best practices prevalent in the industry.

All such facts leave the CSOs and CISOs, the custodian for IT security, searching for solutions that would help him and the enterprise.

As organizations deploy more tools and more technologies to deal with threats, regulations and IT operational issues, the complexity of security management also goes up by a significant amount. However, few organizations consider how they would govern all these safeguards, both technical, process, and people based. A special category of tools, IT GRC management, has emerged to solve these problems.

GRC solutions deliver a higher level functionality than specific security tools (such as network IPS) and even high level than security management tools (such as SIEM). The “G” in GRC—governance—connects security management practices with enterprise wide business processes and governance and with overall business risk that goes beyond information technology.

Good Governance calls for four simple steps: Establish objectives and process for attaining those objectives, and reaching a new state, integrating the fact that this is an iterative process (Plan); Implement the new process (Do); Do something as part of the action plan in moving towards the end results; processes and good practices or mandatory compliance requirements and risk mitigation; Measure new state against expected results (outcomes) to ascertain variance (Check); Learning occurs continuously which can result in redefining the desired state, state, identify the gaps, improve the planning and implementation steps; and Audit to measure the resultant state (was it as expected?-Short of it?-Nowhere near it?) Determine cause of variance, determine changes for improvement, and repeat the sequence (Act).

A PDCA model [Dr. W. Edward Deming] is attached (FIG. 3).

Looking at the information security from a simple 6-A principle: The Six A's are Awareness-Availability-Assessment-Acceptance-Action-Audit. Awareness gets us to recognizing the truth that security threats are a reality and just therefore cannot ignore it. This awareness makes one to look at the ‘availability’ of data within the enterprise through logs, and network packets captured. The next step is to examine the available data which is the assessment phase which includes analysis of the data to pinpoint specific security breaches or understand a broad pattern. The analysis followed by recognition of the threats and accepting the vulnerability, results in action. The appropriateness of the action has to be audited which highlights any existing gap that is still vulnerable and needs to be plugged. This is a continuous process.

Early IT GRC tools were engineered to require massive volumes of Consulting Services (exceeding the cost of the tool itself in most cases). They also had issues handling larger volumes of control and compliance data. Such tools failed to deliver on the promise of peer comparisons across organizations in regards to their approach to security management, compliance management and overall risk management, thus leaving enterprises in the dark about how well they're doing with security, risk and compliance. Finally, the old GRC tools relied on other, often expensive and themselves hard to deploy. Security Products to deliver security monitoring and control assessments.

Traditionally, the information security tools and the compliance management applications are separate application silos, with their own deployments in the enterprise with no interaction and communications amongst them leading to disparate and perhaps incomplete assessment of the business risk. This means that the policies defined by the IT-GRC framework is not calibrated with the reality on the ground as measured through the security assessment and management tools. This can lead to a huge gap in reality about the desired business risk and the reality on the ground, leading to potentially huge risks and liabilities due to threats and vulnerabilities.

A new innovative approach is required to integrate and automate GRC tools by combining compliance workflow with control assessment automation and security monitoring. Such a solution when deployed in the cloud enables simplified deployments, unlimited scalability and extensibility. It enables easier “pay-as-you-grow” subscription based consumption model enabling wide spread adoption through a SaaS model.

New ways of managing new risks—Call for innovative solutions. The next generation Enterprise solution should holistically cover all aspects of threats—internal or external, accidental or deliberate, intentional or unintentional through an effective system of IT governance, well evolved IT Risk mitigation system, and the flexibility and extensibility to plug in the requirements of any new regulation, present or in the future to seamlessly address many compliance requirements. This calls for not only new approach to addressing compliance solutions, but also for information security monitoring, 24×7, for all activities of the Enterprise assets and users in real-time, insiders and outsiders, by fully capturing all the data transferred, by analyzing them for events, patterns, incidents, to make a quick and meaningful analysis of any impending threats. Even where security violations have happened, the solution should bring it to the attention of decision makers in real-time, with all the information required for making a decision before it turns out into a debilitating impact with wide-reaching regulatory impact. For example, relevant regulations, affected critical assets and other information about the affected business function needs to be available immediately after a violation or missing critical control is detected.

Deployed in the cloud, such tools should integrate, security monitoring, automate end-point assessment with compliance and management workflows. They should resolve the security and compliance manageability challenges and break the spell of “management via Excel spreadsheet.” These new tools should deliver value for both strategic and day-to-day compliance management as well as security monitoring and data protection and thus help both executive management and “in the trenches” IT professionals and security analysts.

The combined solution therefore provides: Integrated compliance management and security monitoring. The solution should be configurable as per the security policies requirements for each enterprise; compliance and risk management workflows for management and IT professionals; automatic compliance scanning; multiple global regulations support “out of the box”; Compliance framework should address the compliance requirements of ISO, COBiT, BASEL II, FISMA, PCI, SOX, HIPAA, GLBA, RBI, IRDA, NSE, BSE, MCX, NCDEX, and any global, (industry or country) specific frameworks that require to be complied with. It should come with a readily available and useful content to address the regulations and not require the user to actually pay to build such content; Automated control assessment: it should automate online questionnaires to quickly assess the gaps in compliance, asset management, audit and compliance management, vulnerability checks, extensive report generation facilities, email integration, alert management, workflow schema, user access control, etc Such questionnaire should significantly reduce the burden of assessing the non-technical, policy controls and safeguard; Secure end-point devices (where sensitive and regulated data is stored) that should be easily accessible for remote monitoring and centrally managing, provide endpoint visibility such as the devices accessing a secure network via WiFi, BLUETOOTH, USB, FireWire, PCMCIA, serial and other ports. The security solutions for monitoring the network traffic should cater to the following features: real-time network intelligence and advanced integrated tools for network forensics, fully integrated into risk and compliance views, not only for threat monitoring; full packet capture, use of live network sessions and a rules based analytical process; Not limited by constraints inherent in only using signatures, log files and statistics; it must be ‘obsolete-proof’ through auto-learning capability by offering extensible infrastructure for rules-based and interactive session analysis across the entire protocol stack. From the network to the application layer; it must provide an effective and highly automated process for problem detection, investigation and resolution, mitigating the IT risks lowering the overall business impact; it should address business problems through detection of advanced threats, acceleration of incident response, policy and compliance verification, insider threat identification through 360 view of insider threats, incident impact assessment, and application and content monitoring; just scale up to global enterprises and down to small and medium businesses, struggling under the same regulatory burden as large organizations; capability to integrate multiple solutions to provide a complete picture to truly secure the enterprise and prove that you have indeed done so to the auditors and business partners. The solution must deliver compelling value to the organization and be affordable; cloud based suite of services brings down the cost to enterprises including SMB Cloud delivery and “pay as you go” that would reduce the total cost of ownership compared to legacy tools and on-premise solutions.

An effective and a complete combined solution must provide for a comprehensive security coverage that would simplify the management of multiple compliance mandate and conflicting security goals, deliver objective security metrics and be more affordable than legacy tools through innovative business models built around the cloud infrastructure and SaaS delivery model.

Today's increased mobility, connectivity, complexity combined with demands for increased productivity offers equally increased vulnerability of endpoints wide open to data leakage and theft, introduction of malware and other cybercrime. GRC provides the framework while integrated security monitoring allows assessing technical controls, validating the policy implementation and assessing risk management dynamically to ensure efficacy of the IT-GRC management system.

Thus, a new generation of solutions is a compelling requirement that should integrate IT GRC and security monitoring tools to finally deliver on the vision of “a single pane of glass” for CSOs, allowing them to effortlessly view all security and compliance issues across the organization, its partners and service providers.

The present invention is a comprehensive solution of all enterprise security, governance, risk management, audit and compliance needs through a unified solution offering. It is the first break through solution as it provides a comprehensive solution to address all aspects of information security and IT compliance. The present invention delivers what customers have been looking for—an integrated solution for security and IT-GRC through an integrated dashboard facilitating comprehensive log management, network monitoring and end-point assessment

The present invention binds the GRC elements with strong security monitoring. It addresses all the requirements for the next generation unified solution mentioned above and a lot more.

The present invention includes all security and IT-GRC functions required to be compliant with ready to use compliance frameworks from across the world, leading edge context-based inference engines, most advanced alert processing and an easy-to-use logging and monitoring solution. It has built-in framework support for Compliance requirements of many countries which are ready to use and deliver value during the audits.

The present invention helps to assess and proactively deal with business risks, security threats, compliance policy and other IT-Security and GRC policy controls. It provides integrated coverage of security and compliance management, from endpoints and networks to management workflows and reporting, from end-point security through Network forensics and advanced threat detection to ensuring compliance with regulations as required in any country A solution is deployed in the cloud with on-premise and hybrid option an available on request.

The present invention is offered as a ‘pay-as-your-grow’, Software-as-a-service (SaaS) model targeted at Enterprises, including small and medium business segments. Through a patent pending innovate architecture and algorithms, the present invention's solution lowers the total cost of ownership dramatically, and thereby enabling enterprises, including SMB's to adopt IT-GRC and Information security services at a fraction of the cost of any other available solution.

Multiple deployment models are available including hybrid deployment models with on-premise software component if required (Customer Premises Equipment). It helps reducing the cost of IT Security significantly compared to other legacy tools, deployed as traditional enterprise software.

Below are some additional data regarding some of the mechanisms of this invention. Integrated compliance management and security monitoring-solution should be configurable as per the security policies requirements for each enterprise; compliance and risk management workflows for management and IT professionals; automatic compliance scanning.

The solution integrates compliance management and security monitoring application silos. Information from both these hitherto separate application domains is leveraged by combining information from both these sources to derive a unified view of risk and compliance.

Information from packet capture of all traffic traversing the network, device logging information generated by all the devices in the enterprise and end-point security related information are used along with the compliance policy regulations to determine a much more accurate picture of existing threats and vulnerabilities. The information from multiple sources is used to infer an improved and accurate view of the compliance (and non-compliance) along with the state of the security protection available to the enterprise. This is in turn used to assess a more accurate value of the business risk for the Enterprise which leads to the end objective—to minimize the business risk exposure.

Multiple global regulations support “out of the box”; Compliance framework should address the compliance requirements of ISO, COBiT, BASEL II, FISMA, PCI, SOX, HIPAA, GLBA, RBI, IRDA, NSE, BSE, MCX, NCDEX, and any global, industry- or country-specific frameworks that require to be complied with. It should come with a readily available and useful content to address the regulations and not require the user to actually pay to build such content

Multiple regulations are packaged with the present invention so that they are ready to use by the customer. The customer can also customize it to their specific needs. Customizing the framework could be done as per enterprise requirements, or country specific requirements or maybe due to a new regulatory compliance that needs to be implemented. This is implemented using a very flexible architecture and framework that can be changed on the fly based on the requirements of the policy being implemented. This is done using a data driven approach wherein the file data with the regulation in a particular format is read and the policy implications understood and internalized by the system. The result is that the system is able to interpret the policy requirements, implement and enforce it through a software based tool to ensure compliance and security monitoring.

Automated control assessment—It should automate online questionnaires to quickly assess the gaps in compliance, asset management, audit and compliance management, vulnerability checks, extensive report generation facilities, email integration, alert management, workflow schema, user access control, etc Such questionnaire should significantly reduce the burden of assessing the non-technical, policy controls and safeguard.

There is a built in workflow management system that enables work flow management to coordinate generation, sending, approving and integrating the various policy related questionnaires, as required by regulations or security guidelines, by involving the various stakeholders in the organization. There can be multiple stakeholders involved in an organization such as administrator, viewer of the dashboard, management approvers, compliance approvers and auditors and all these stakeholders have the ability to participate in the workflow to create policy related questionnaires and to respond to them using the workflow management system.

Secure end-point devices—where a lot of sensitive and regulated data is stored—that should be easily accessible for remote monitoring and centrally managing, provide endpoint visibility such as the devices accessing a secure network via WiFi, BLUETOOTH, USB, FireWire, PCMCIA, serial and other ports

End-points such as computers, servers, Databases, devices (such as firewalls) etc. are prone to data breaches and security threats that can be very expensive to deal with for the Enterprise. There is a need to secure the devices and leverage any information about potential breach attempts, successful uses, role based access control related information to be made available in order to enable the present invention to determine if any attacks may be taking place and to correlate that with the observations in the other parts of the enterprise. This will enable detection of attacks in a proactive fashion and use remediation techniques to secure the end-point under attack while alerting the administrator. This will lead to a highly aware and intelligent security and compliance management system.

The security solutions for monitoring the network traffic should cater to the following features: real-time network intelligence and advanced integrated tools for network forensics, fully integrated into risk and compliance views, not only for threat monitoring; full packet capture, use of live network sessions and a rules based analytical process; not limited by constraints inherent in only using signatures, log files and statistics; must be ‘obsolete-proof’ through auto-learning capability by offering extensible infrastructure for rules-based and interactive session analysis across the entire protocol stack—from the network to the application layer; provide an effective and highly automated process for problem detection, investigation and resolution, mitigating the IT risks lowering the overall business impact.

All packets passing through the network in real-time are captured, all log information generated by various devices in the enterprise environment in real-time (devices are computers, servers, firewalls, storage, Databases etc.) are captured and end-point related security information is captured. This information is then normalized and categorized into various event categories to make sense of all the data being generated by the different parts of the enterprise.

These events are then mapped to incident signatures which are then interpreted by a correlation rules driven inference engine to ascertain threats and vulnerabilities that may be exposed. The inference engine is a very sophisticated brain which has the auto learning capability to understand the new threat landscape as it emerges through new signatures that are generated automatically by the system or by input provided by the system administrator which defines in a natural language or programming language a description of the new threats that are possible. The solution will also has the ability to do forensics to go back in history and deep dive into incidents that may have been missed as the threats may not have been known at that time.

It addresses business problems through detection of advanced threats, acceleration of incident response, policy and compliance verification, insider threat identification through 360 view of insider threats, incident impact assessment, and application and content monitoring.

There are built in algorithms to deal with detection of threats and to respond to adverse incidents, if any that are detected, by contacting the correct stakeholders such as the system administrator or the chief security officer in the company. Business logic is used to determine the rightful owner and persons who are allowed to access data or information in the enterprise. If the role based access control policies are violated, that is flagged as a notice worthy event, which could be due to insider or outsider breaches. Based on the incident a quick assessment of risk is done of the situation which is in turn used to determine non-compliance and security breaches. Intelligence from the Enterprise Identity management system and the business rules for roles based access control for enterprise information and data is used to determine the non-compliance and security breaches.

A cloud based hosted software service solution enables the “pay-as-you grow” consumption model. Multiple subscription based consumption models are available such as monthly or a yearly subscription. Enterprises can decide to pay on a monthly basis if they like, the subscription based consumption size can vary depending on the enterprise needs at the particular time. There is no need to buy upfront capacity or to invest in capital to buy the fully enabled solution upfront. Instead the payments made towards the service are deemed as operating expenses and as the capacity requirements for the service grows, the enterprise can pay more as and when their service needs grow.

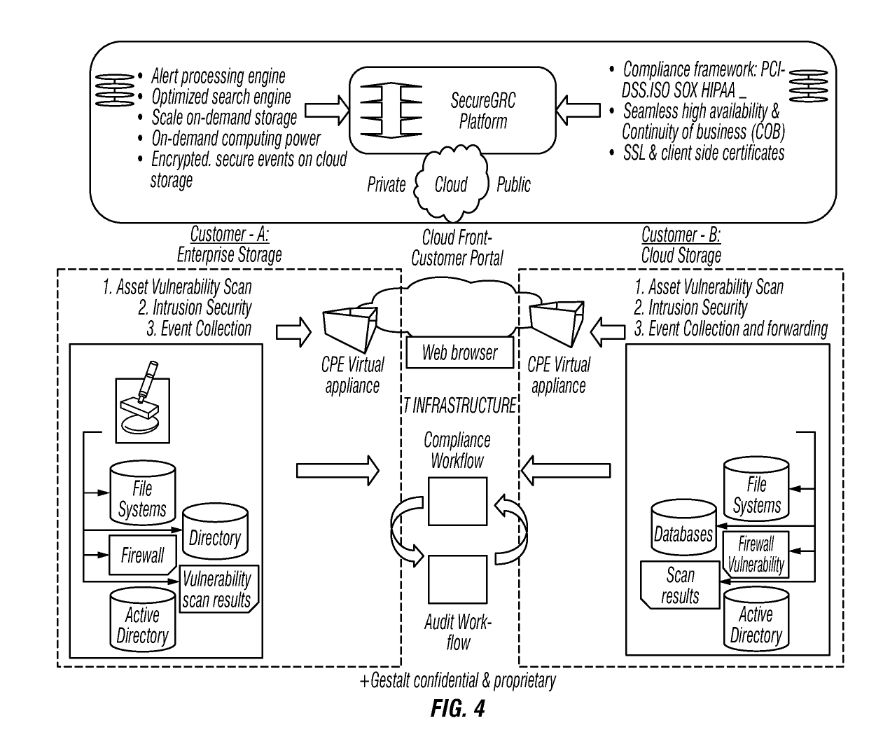

This implies that the architecture of the solution is such that the backend infrastructure can scale up on demand as the customer demand grows and this can be done dynamically on the fly. The architecture is scalable with additional capacity for CPU's, storage and event processing and inferencing capability that will scale up automatically as well. A picture of the architecture is shown (FIG. 4).

Capability to integrate multiple solutions to provide a complete picture to truly secure the enterprise and prove that you have indeed done so to the auditors and business partners

The solution must deliver compelling value to the organization and be affordable Cloud based suite of services brings down the cost to enterprises including SMB Cloud delivery and “pay as you go” that would reduce the total cost of ownership compared to legacy tools and on-premise solutions

By integrating security monitoring and compliance management application silos and delivering it through a cloud based infrastructure which can be acquired on a “pay-as-you-grow” basis. There is an ability to deliver more accurate business risk assessment through better information security and compliance management implementation. This is possible at a fraction of the cost of the combined solutions. Today a customer will typically buy and deploy separate applications and infrastructures for information security monitoring and IT-GRCM. The present invention provides one application which can serves all the enterprise needs for Information security monitoring and IT-GRC Management leading to a lower cost of deployment and lower cost of management and better more effective business risk management for the reasons mentioned above.

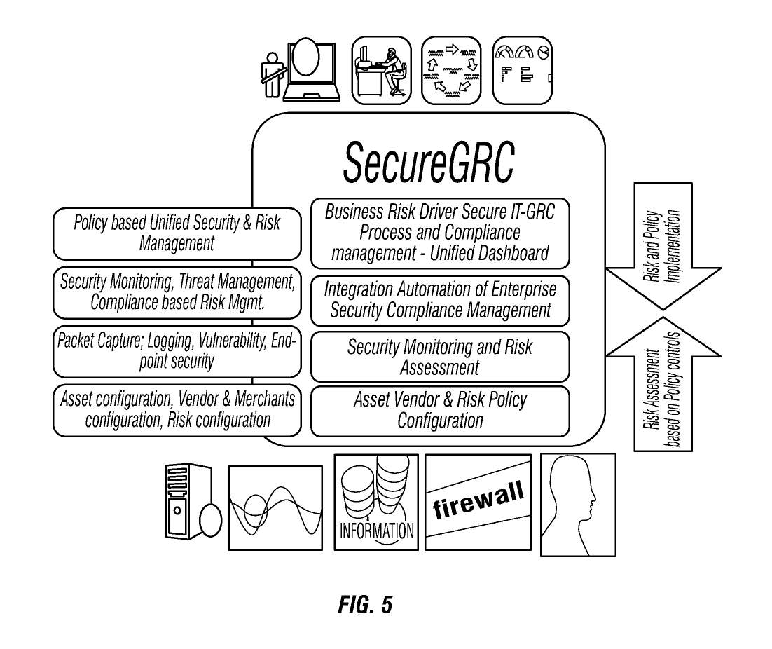

A layered functional diagram on how this is achieved is shown (FIG. 5). The work flow and detailed steps are as follows. The left stack (yellow) depicts the high-level functionality layering view of the architecture of the present invention and he right stack (blue) depicts the business-level end-user layering view of the architecture of the present invention.

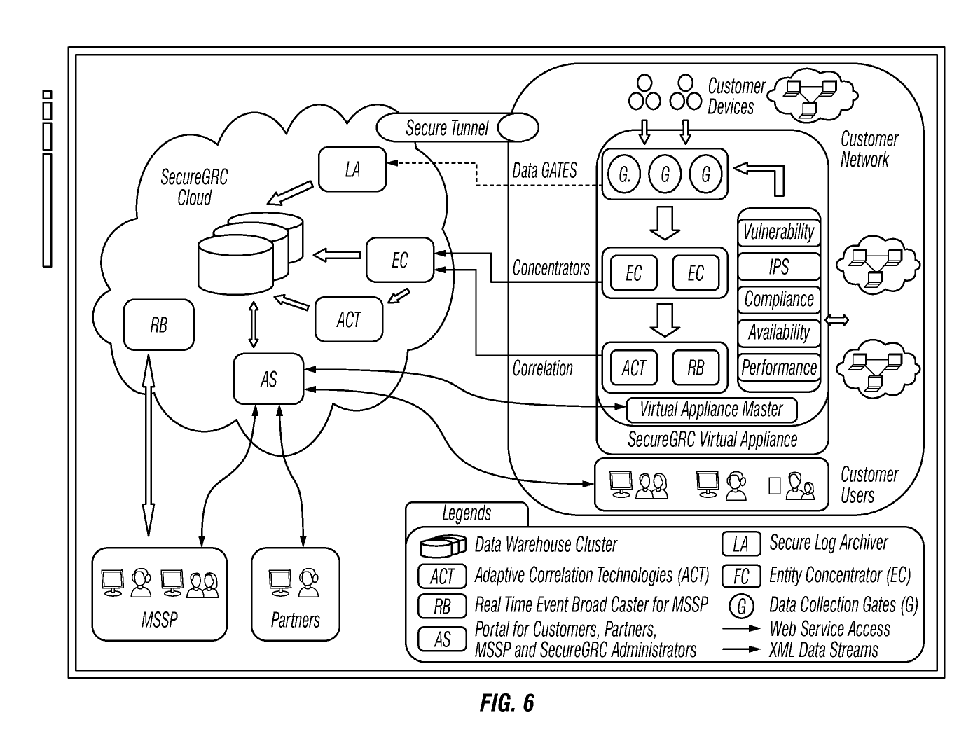

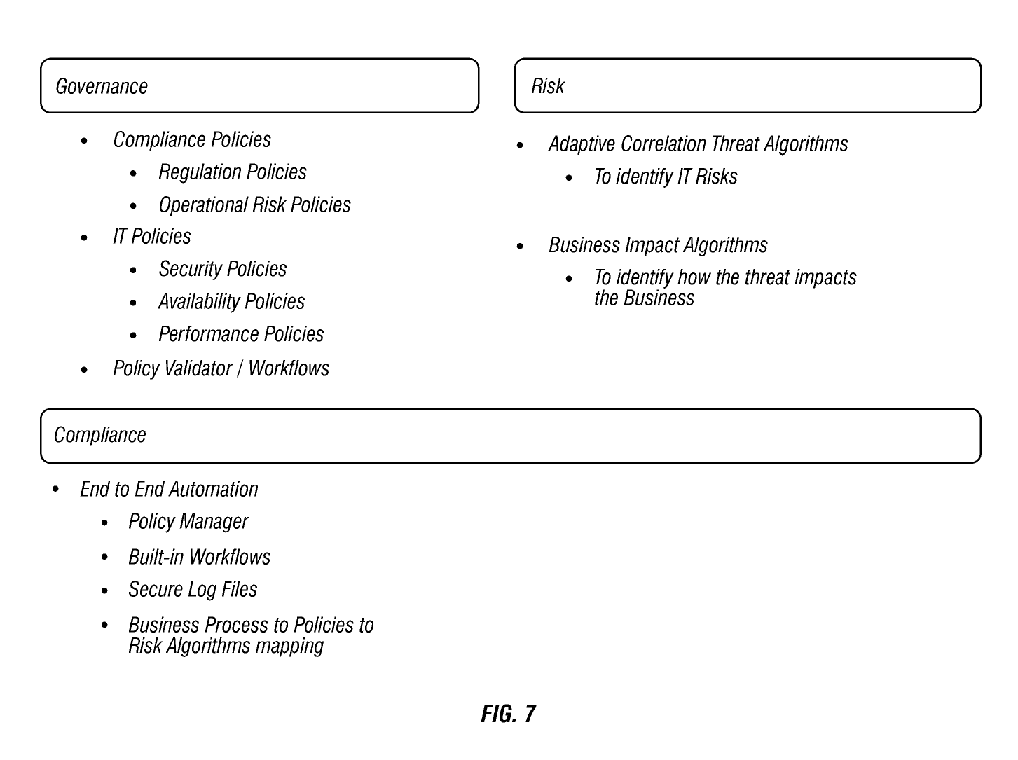

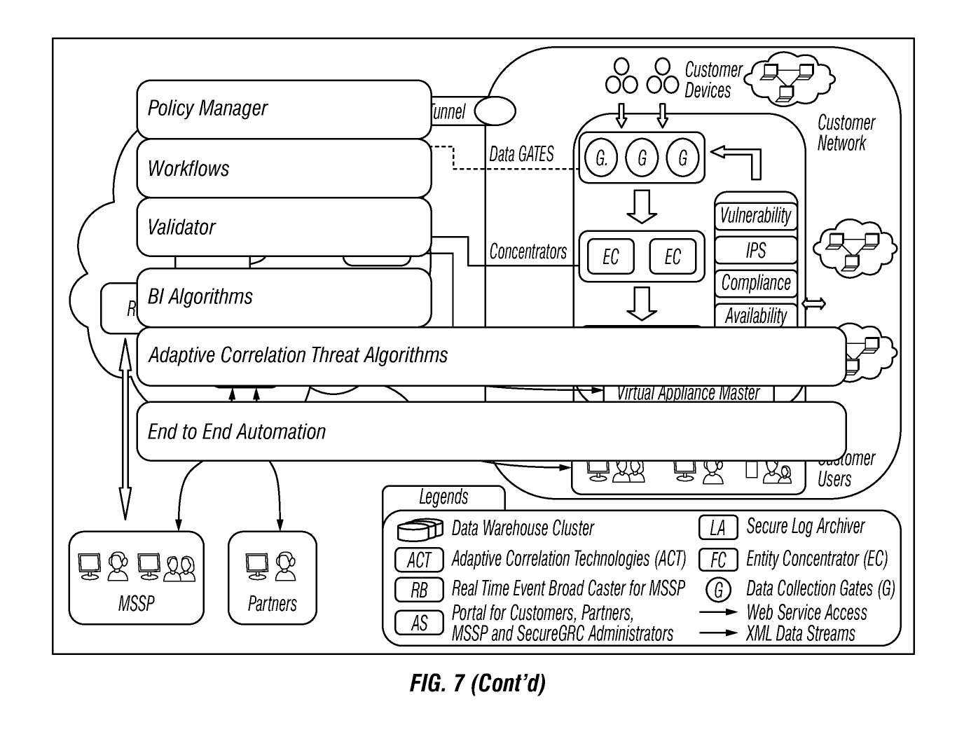

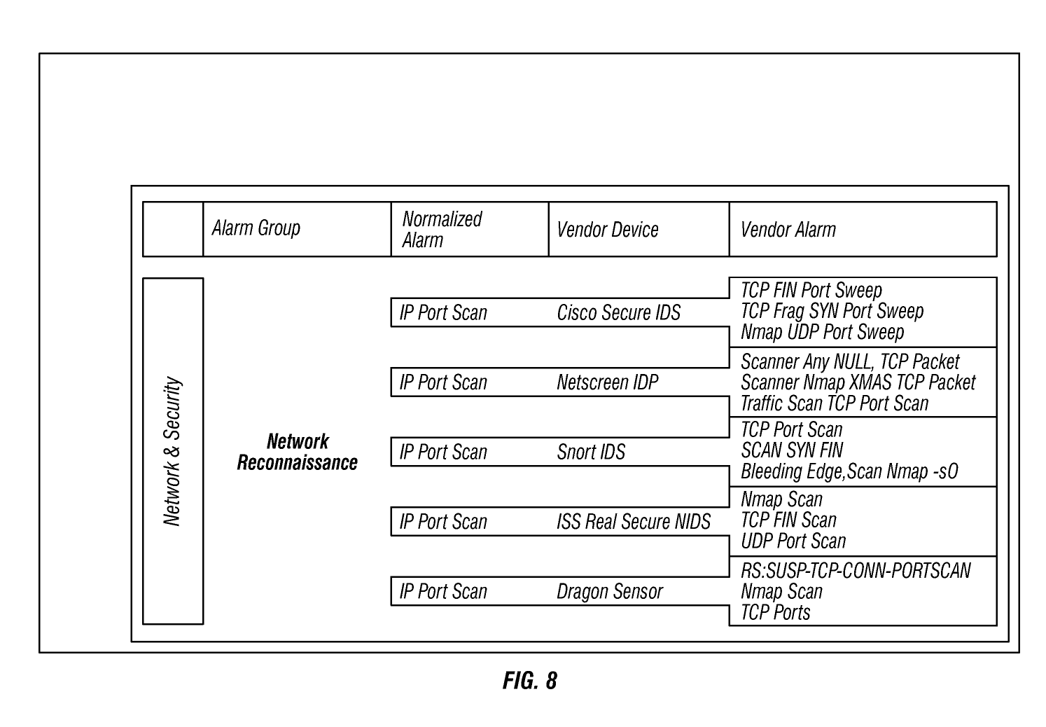

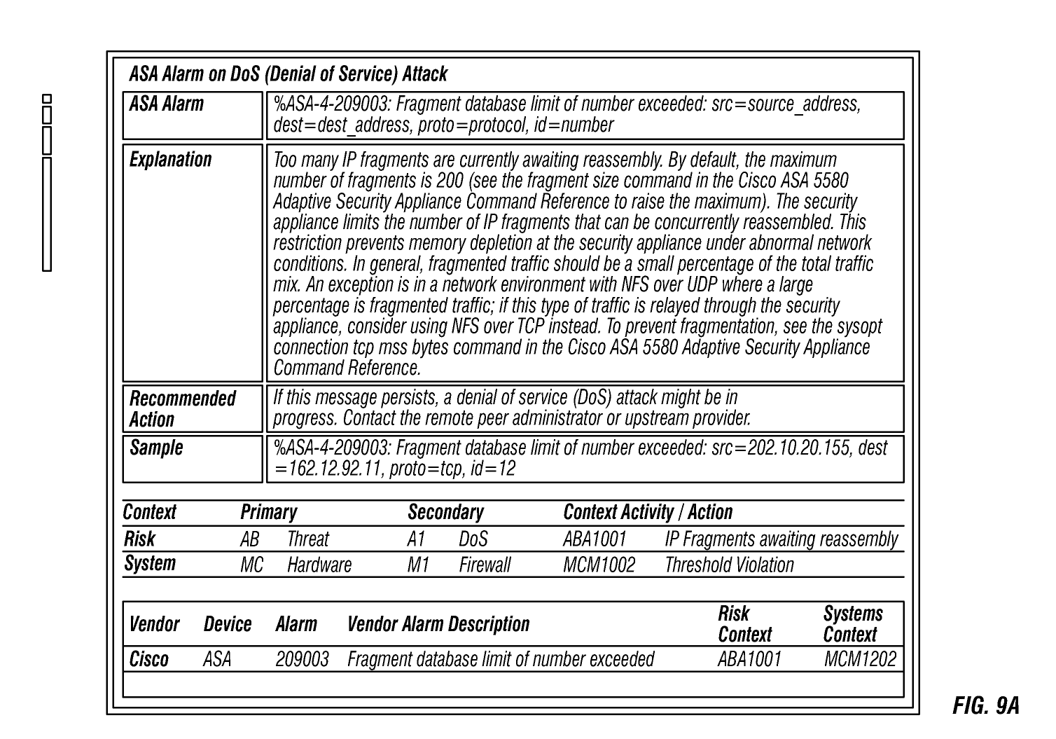

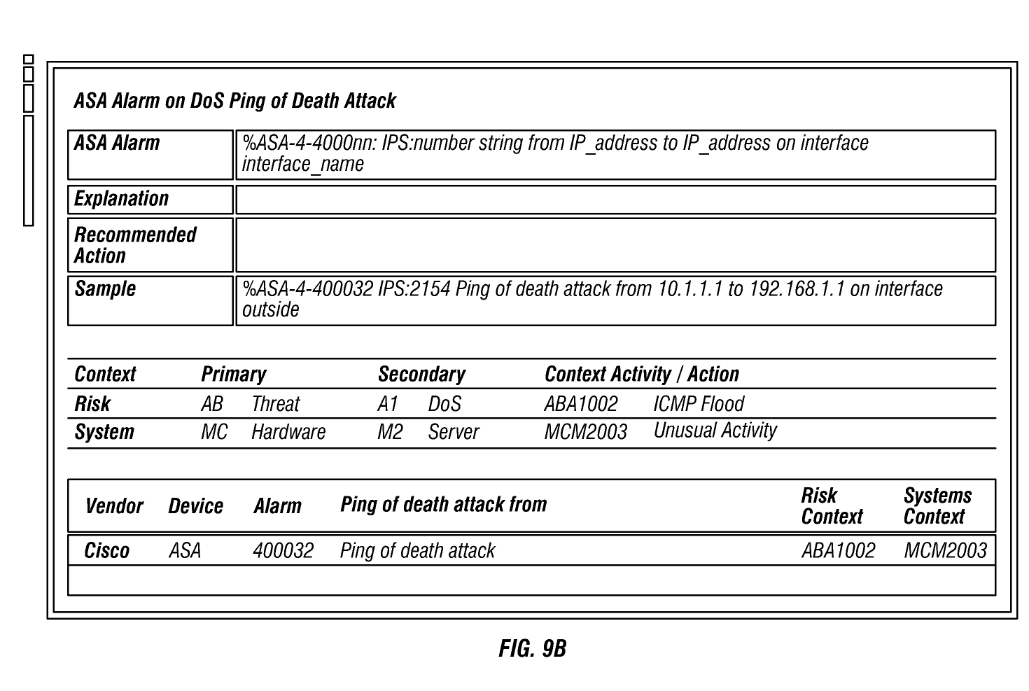

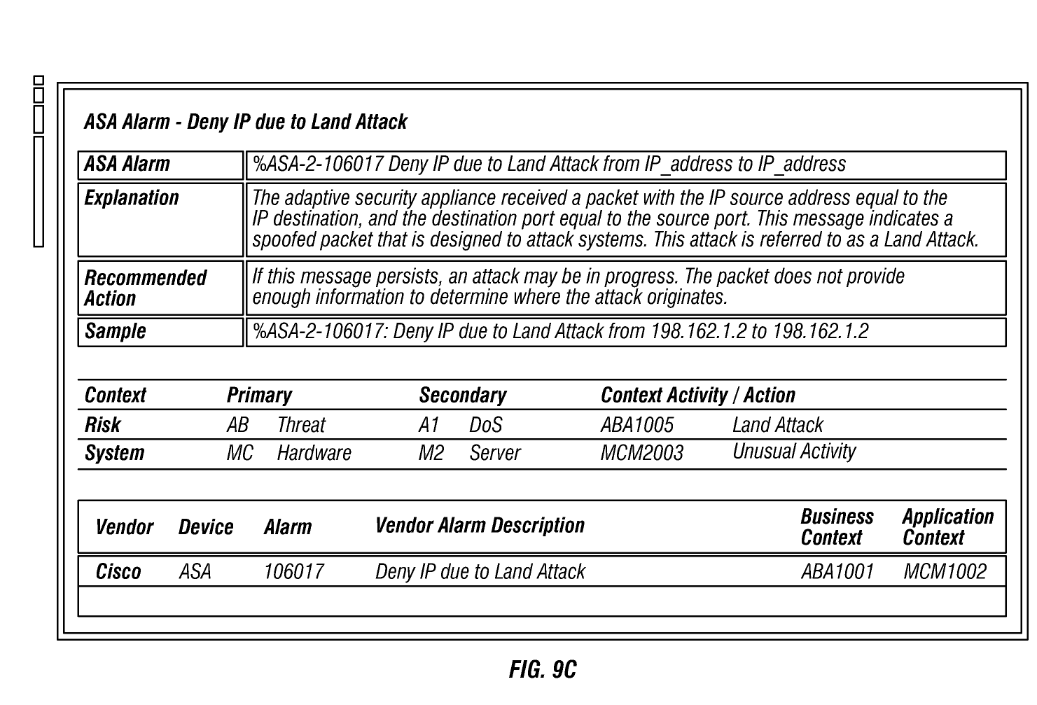

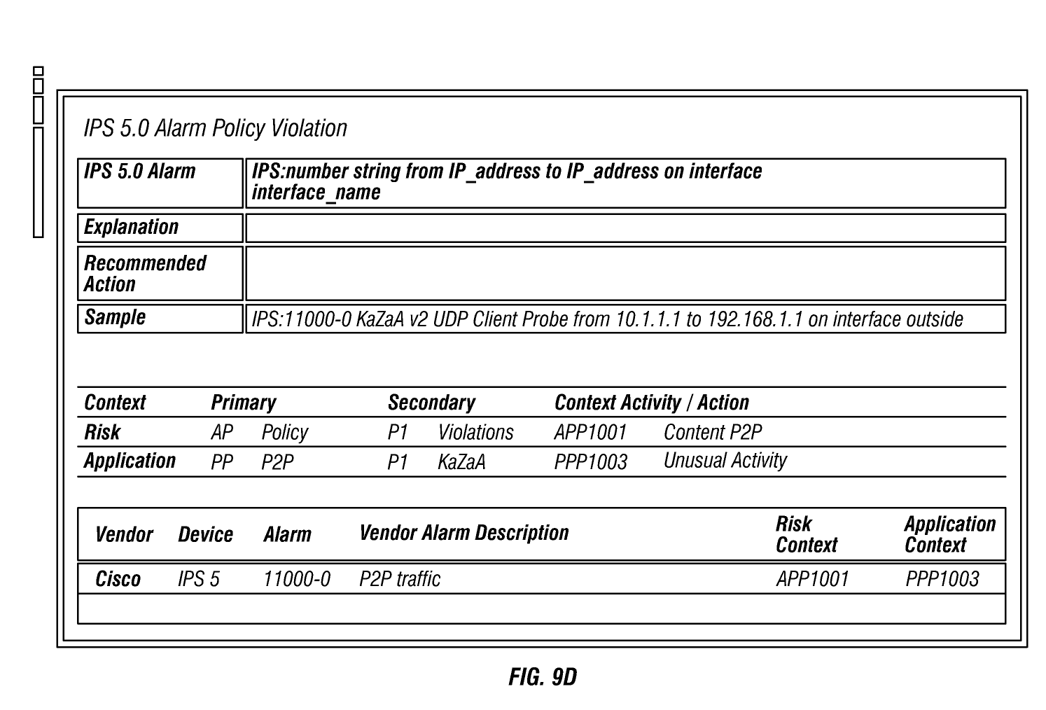

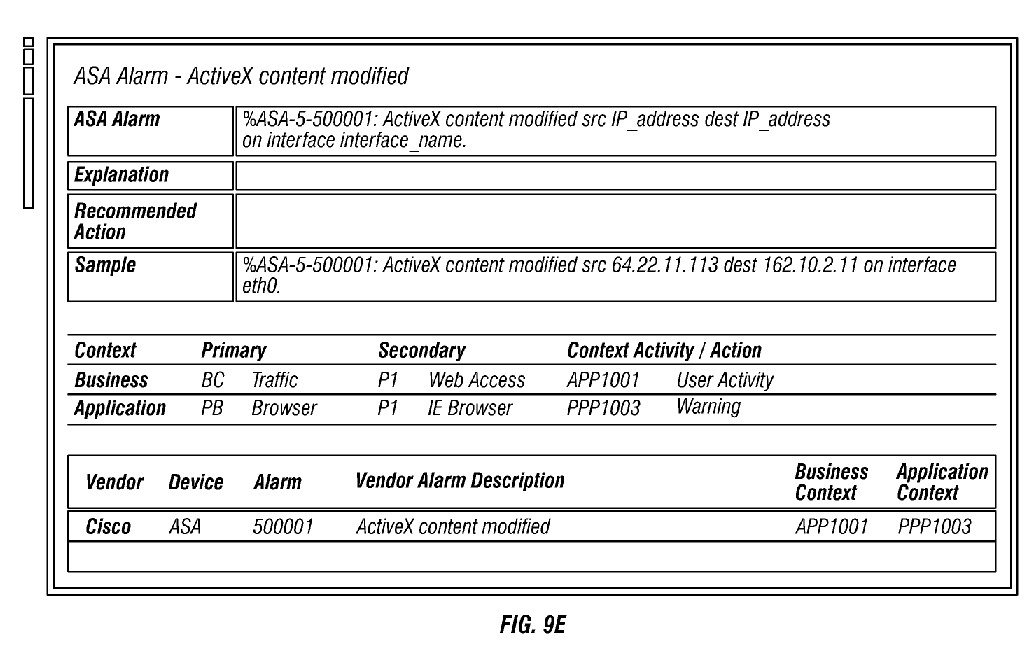

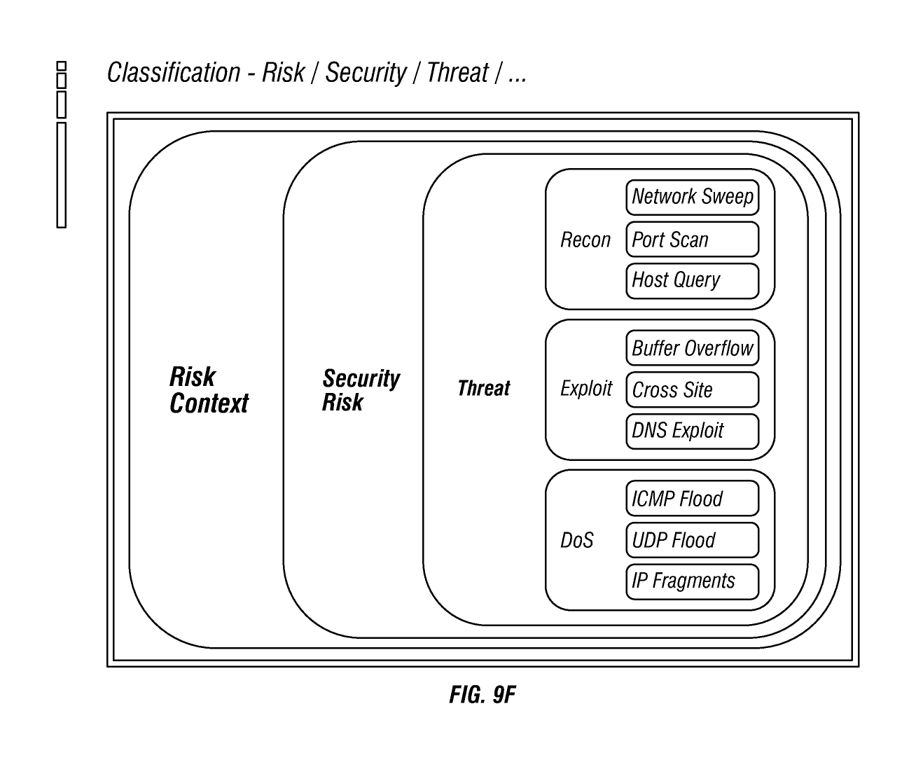

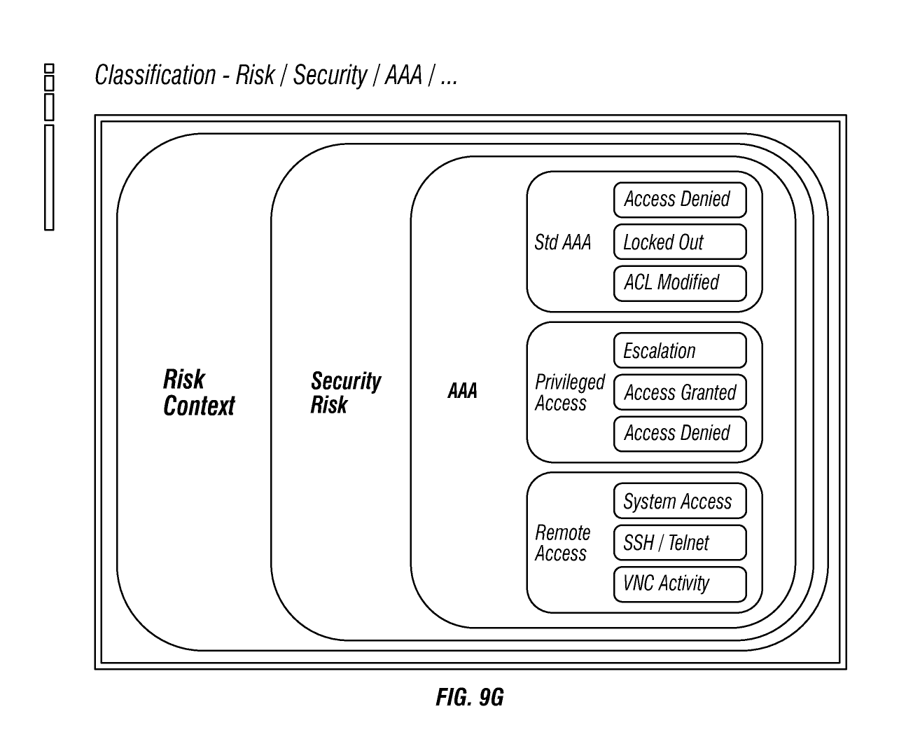

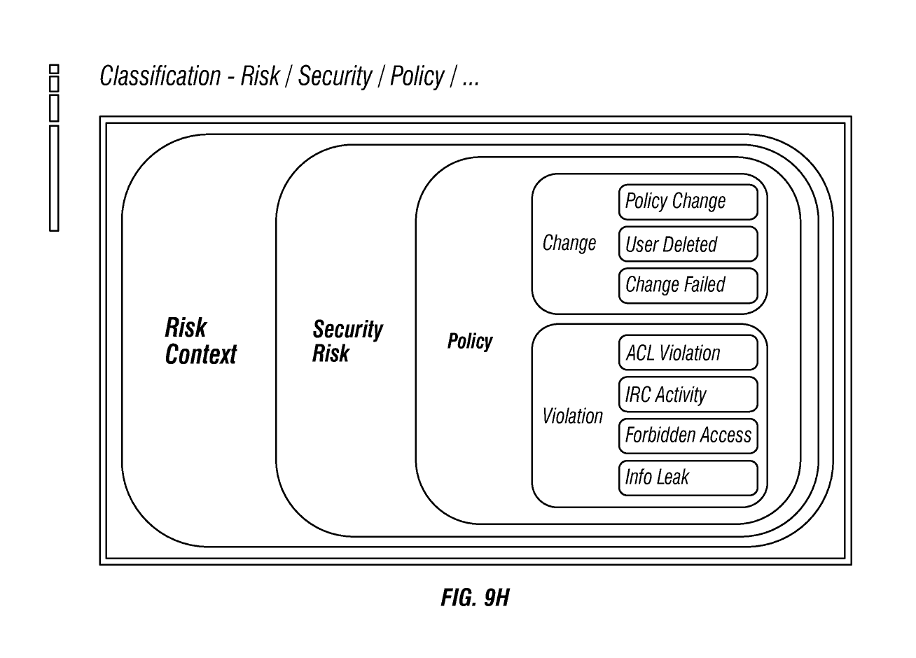

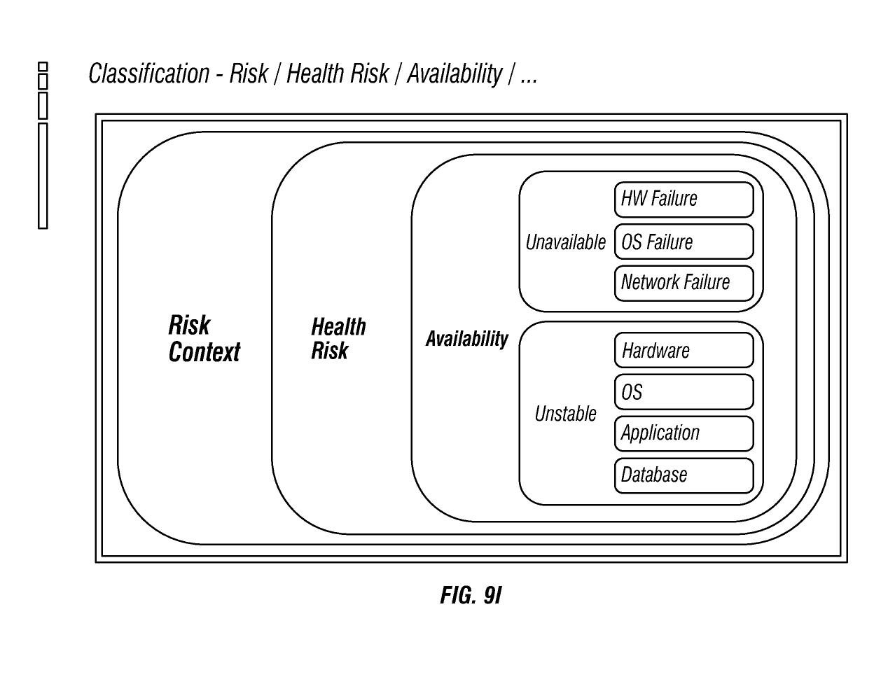

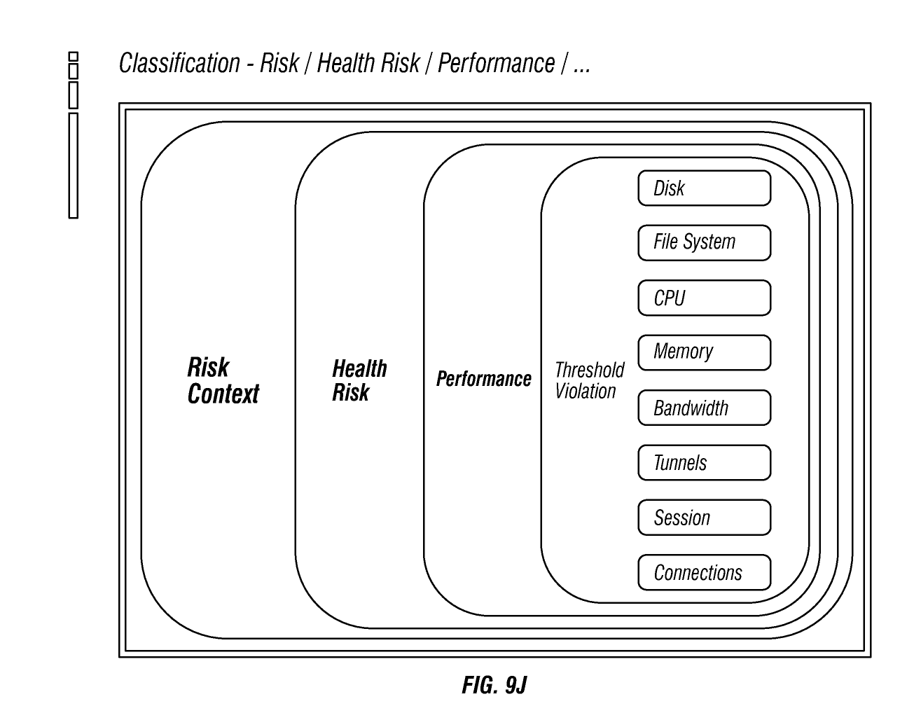

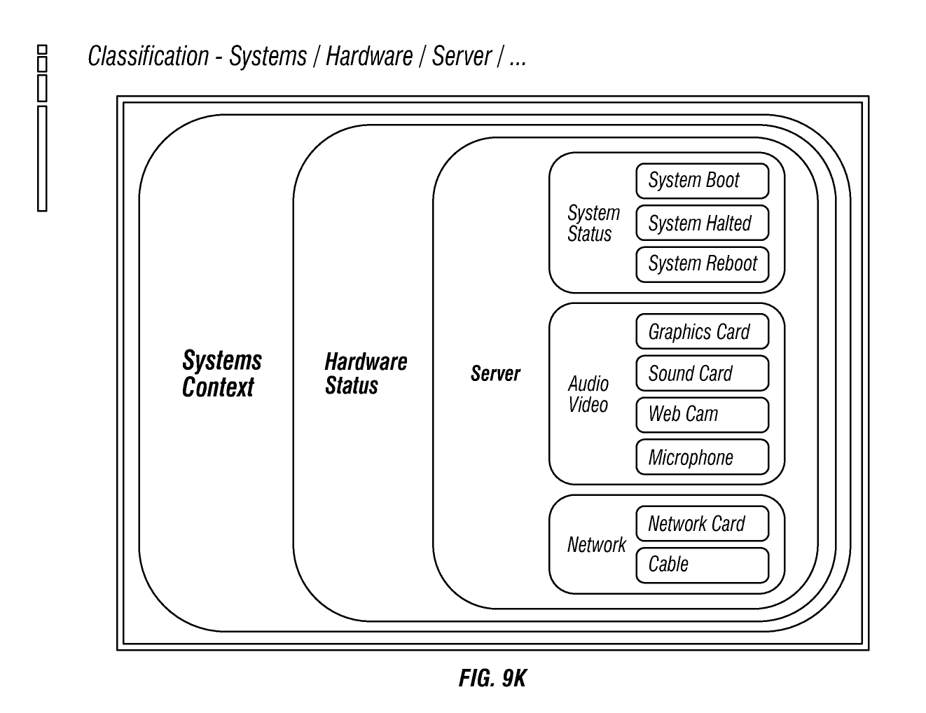

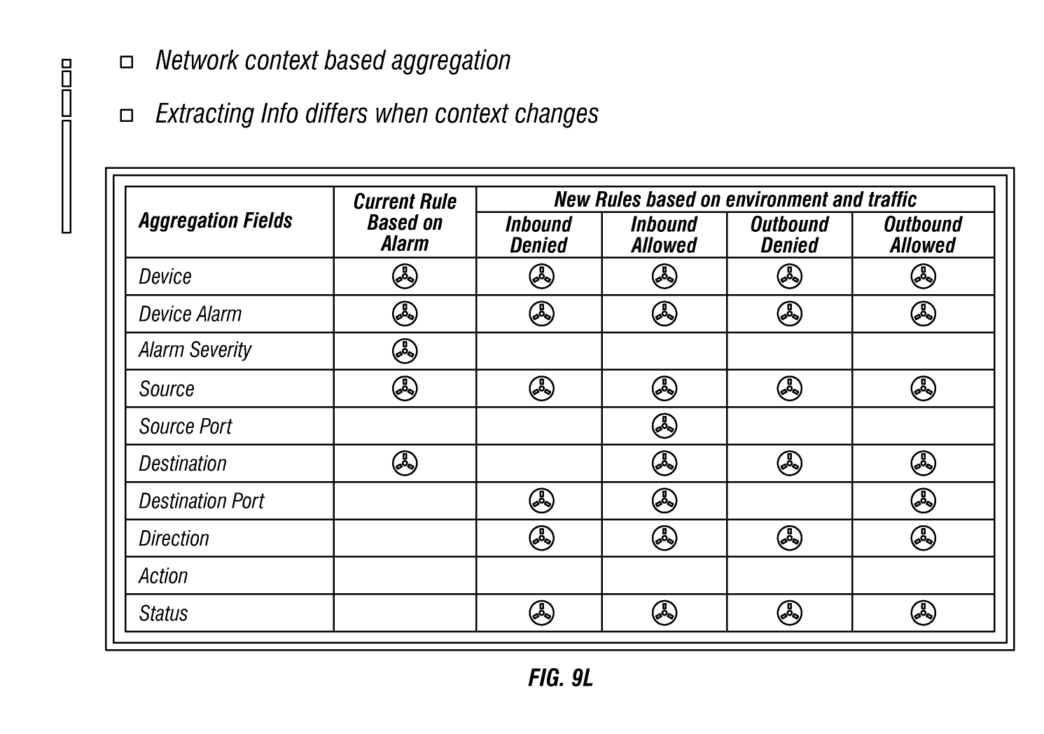

FIG. 6 depicts the cloud architecture. FIG. 7 depicts the mapping to the architecture. FIG. 8 depicts the 6 dimensional data normalization. FIGS. 9a-9l depict examples of multidimensional data normalization.

### DEFINITIONS

Asset It defines Information as an asset that may exist in many forms and has value to an organization. To elaborate it further there is a general belief that information security is only related to information held in computer systems and it can be protected using IT technologies like Firewalls, Intrusion Detection Systems, Antivirus Software's strong user authentication mechanisms etc. However, the reality is Information will take many forms in within an organization, paper documents, presentations, drawings, designs, files, knowledge etc. All these information needs to adequately secured.

Availability Availability is a characteristic that applies to assets. An asset is available if it is accessible and usable when needed by an authorized entity. In the context of this standard, assets include things like information, systems, facilities, networks, and computers. All of these assets must be available to authorized entities when they need to access or use them.

Confidentiality Confidentiality is a characteristic that applies to information. To protect and preserve the confidentiality of information means to ensure that it is not made available or disclosed to unauthorized entities. In this context, entities include both individuals and processes.

Control A control is any administrative, management, technical, or legal method that is used to manage risk. Controls are safeguards or countermeasures. Controls include things like practices, policies, procedures, programs, techniques, technologies, guidelines, and organizational structures.

Information Security Event An information security event indicates that the security of an information system, service, or network may have been breached or compromised. An information security event indicates that an information security policy may have been violated or a safeguard may have failed.

Information Security Policy An information security policy statement expresses management's commitment to the implementation, maintenance, and improvement of its information security management system.

Integrity To preserve the integrity of information means to protect the accuracy and completeness of information and the methods that are used to process and manage it.

Residual Risk Residual risk is the risk left over after you've implemented a risk treatment decision. It's the risk remaining after you've done one of the following: accepted the risk, avoided the risk, transferred the risk, or reduced the risk.

Threat A threat is a potential event. When a threat turns into an actual event, it may cause an unwanted incident. It is unwanted because the incident may harm an organization or system.

Vulnerability Vulnerability is a flaw or weakness in a system security, procedures, design, implementation, or internal controls that could be used to create a security breach or violation of the Organization Security Policy or Regulatory Compliance.

Today, the Risk Management (Information Security, Systems Availability, Systems Performance and IT-GRC—Governance, Risk, Compliance) are separate islands of Risk Management. In today's competitive business climate, IT has moved from a support organization to focus on business service delivery. While striving for continuous service improvement and a secure environment IT executives are challenged in managing different silos of Information and Risk management solutions. Unifying these silos manually is a challenge in itself.

The present invention is a Unified Enterprise Risk Model that focuses on bringing all the different silos (Information Security, Systems Availability, Systems Performance and IT-GRC) into a single Unified Enterprise Risk Model. The set of Risk Algorithms works from two different perspectives identifying the Threat (to Business) and then figuring out the Business Impact and collectively resulting in a Unified Risk Profile. Unified Risk Profile is well beyond the tradition of Risk Mitigation (using controls and process to limit exposure to problems). This invention focuses on how Business Risk Computation with compliance, threat and behaviour posture as an input to create a Unified Approach to Business Risk Computation.

The most difficult task because of the different Silos is the Qualitative Risk Analysis while Quantitative Risk Analysis is straight forward it still has problem areas. This document focuses on Qualitative Risk Analysis first and then move to Quantitative Risk Analysis. In this section the focus is on Security Information and how these information is classified and how it stops the system from having an Automated Unified Enterprise Risk Model.

Current Normalization structure followed by the industry is only in a single dimensional model. It looks at events coming from various security data sources like Firewalls, IDS/IPS, End-point Security Solutions and map it into a rigid pyramid kind of structure. It focuses more on threat while conveniently ignoring the normal business traffic. This results in a signature kind of threat detection where the only known threat can be detected. A Change in Threat pattern will be treated as false negatives (missing the threat by the system).

The current practice of single dimensional normalization is only trying to figure out the enemy without understanding your own network or infrastructure. Placement of the Asset and its exposure to users is critical in understanding the vulnerability impact on that Asset. In the Unified Enterprise Risk Model this area is more elaborated under Information Analysis Section. This is one of the key areas of Unified Enterprise Risk Model.

From the challenges we have seen so far, let us conclude the main which put hurdles in the coming out with a Unified Enterprise Risk Model. Single Dimensional Security Data Normalization Model ignores the Normal Business traffic; Normalization model follows a signature pattern to identify the threats.; Not understanding the network and its behaviour results in missing new attacks and finding new attacks almost impossible; As the normal behaviour is ignored it results in some of the very key elements required to understand the overall Risk is missed out. The Unified Enterprise Risk Model resolves these challenges.

Qualitative Risk Analysis is more complex especially when you combine Security, Availability, Performance and IT-GRC. The following 10 topics identifies the parameters for Unified Qualitative Risk Analysis. Process Audit Analysis; Information Analysis; Asset Profiling; Threat Identification; Vulnerability Identification; Likelihood Determination; Impact Analysis; Compliance Analysis; Risk Determination; and Controls and Recommendations.

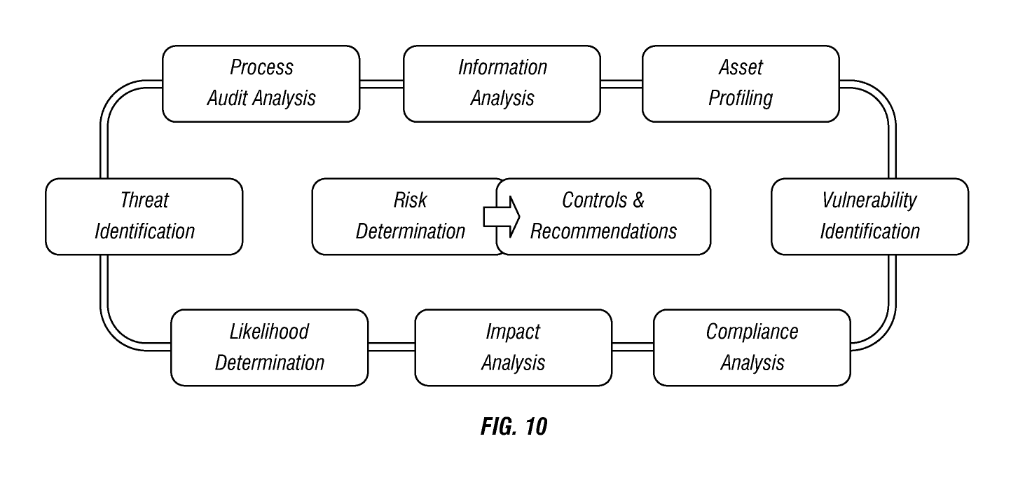

FIG. 10 illustrates how various sub models revolves around the Risk Determination Algorithm. To have a Unified View every entity (Process, Person, System, Applications, Network) needs to be analysed and quantified using a normalized structure and information. It needs to create a repeatable and measurable output.

One of the key elements in the Unified Risk Assessment is Information Analysis. With a unique Normalization algorithm, the information is mapped under various Business and Asset Contexts. The output of this creates an Information Matrix which shows the General behaviour of the information flow across the enterprise.

| Inputs | Outputs |
|---|---|
| Data Normalization | Information Matrix |
| Information Classification | |
| Base Lining the Data | |
| Behaviour Analysis | |

Information Analysis is broadly classified into two contexts. All the information entering into the model will classified/linked under the both the context, either business context, or asset context.

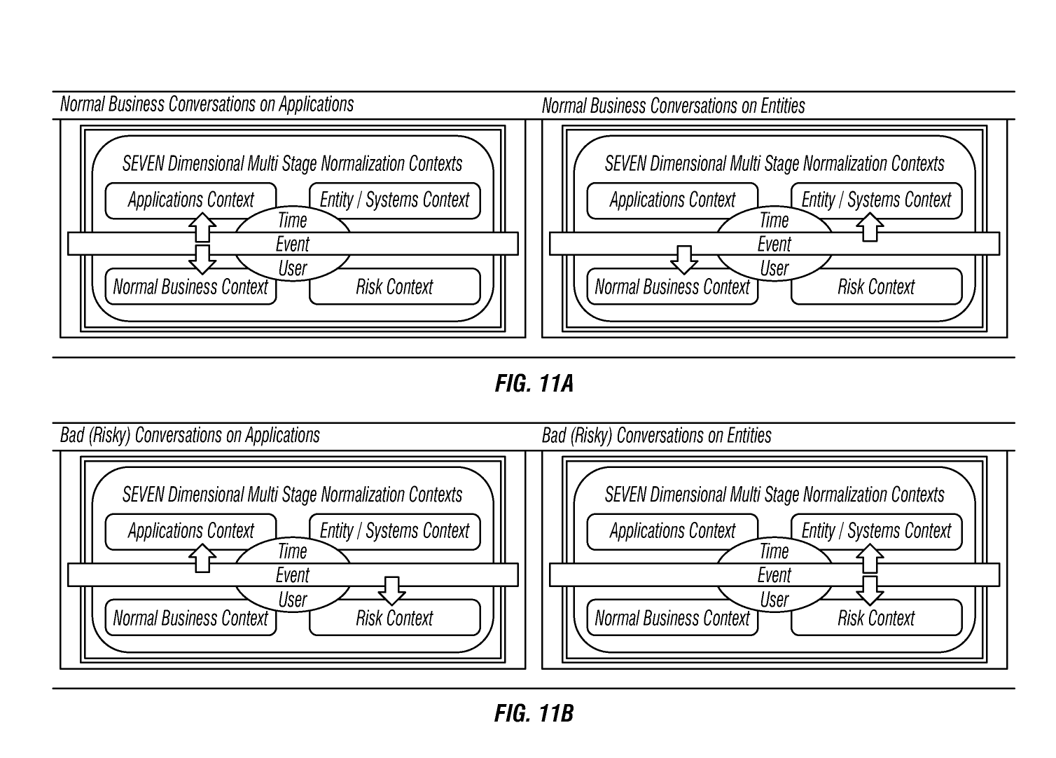

FIGS. 11a-11b show how the contexts are mapped to events. Any event can be mapped into two different perspectives in four different ways. It identifies the conversations happening in the network. Conversations can be between two systems, a user and a system etc. The different ways are: Normal Business Conversations on Applications; Normal Business Conversations on Systems; Bad (Risky) Conversations on Applications; Bad (Risky) Conversations on Systems.

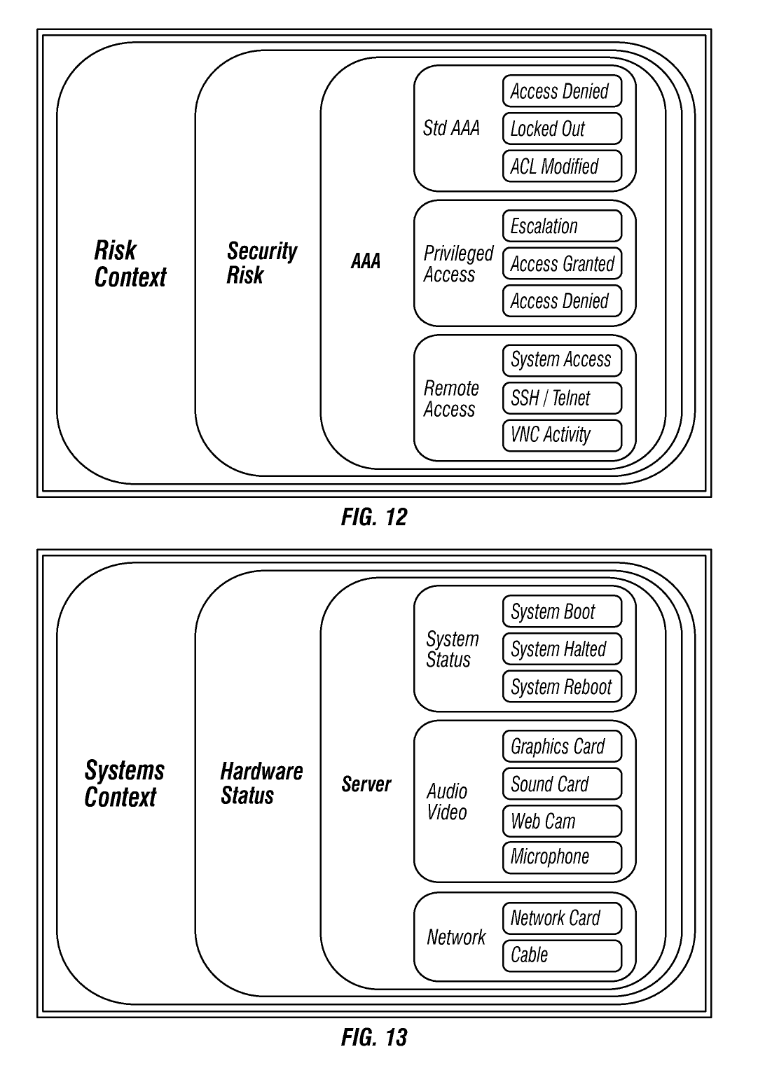

Business Context is further divided into two sub context: Normal Business Context (All normal business traffic); and Risk Context (All Risk traffic). These sub contexts are further sub divided into three granular levels to clearly identify the traffic pattern. FIG. 12 depicts business content with risk classification.

Asset Context is further divided into two sub context: Application Context; and Systems Context. FIG. 13 shows these subcontexts are further sub divided into three granular levels to clearly identify the Assets.

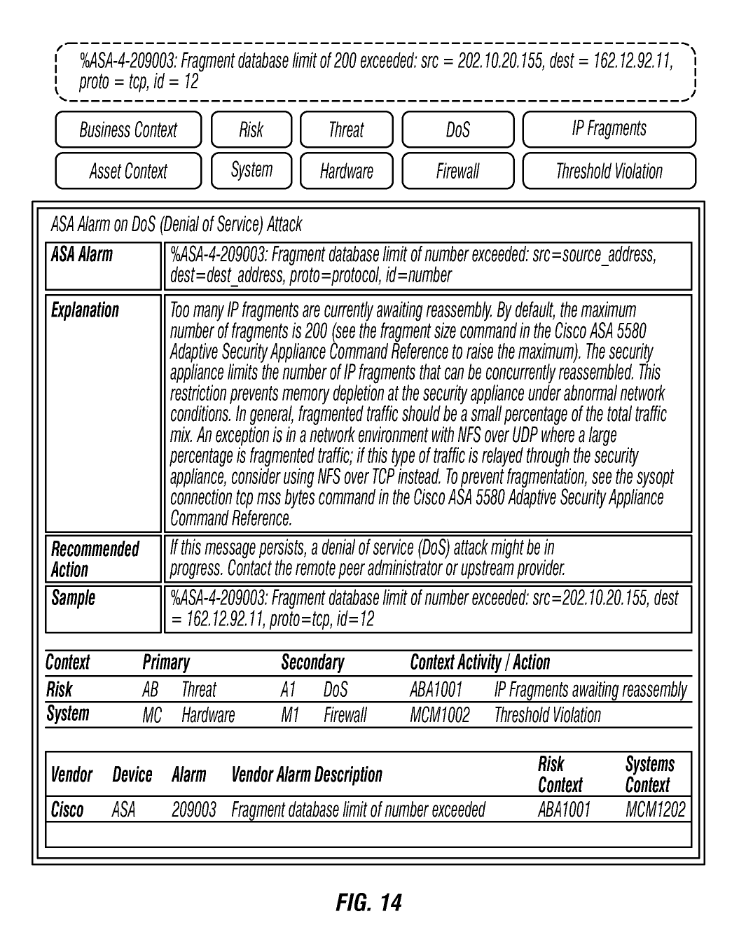

FIG. 14 depicts illustrates the multi-dimensional context mapping for events. FIG. 14 shows an event from Cisco ASA which says if these events persist, a Denial of Service attack might be in progress.

In the FIG. 14 example a single event is tagged with following tags % ASA-4-209003: Fragment database limit of 200 exceeded: src=202.10.20.155, dest=162.12.92.11, proto=tcp, id=12.

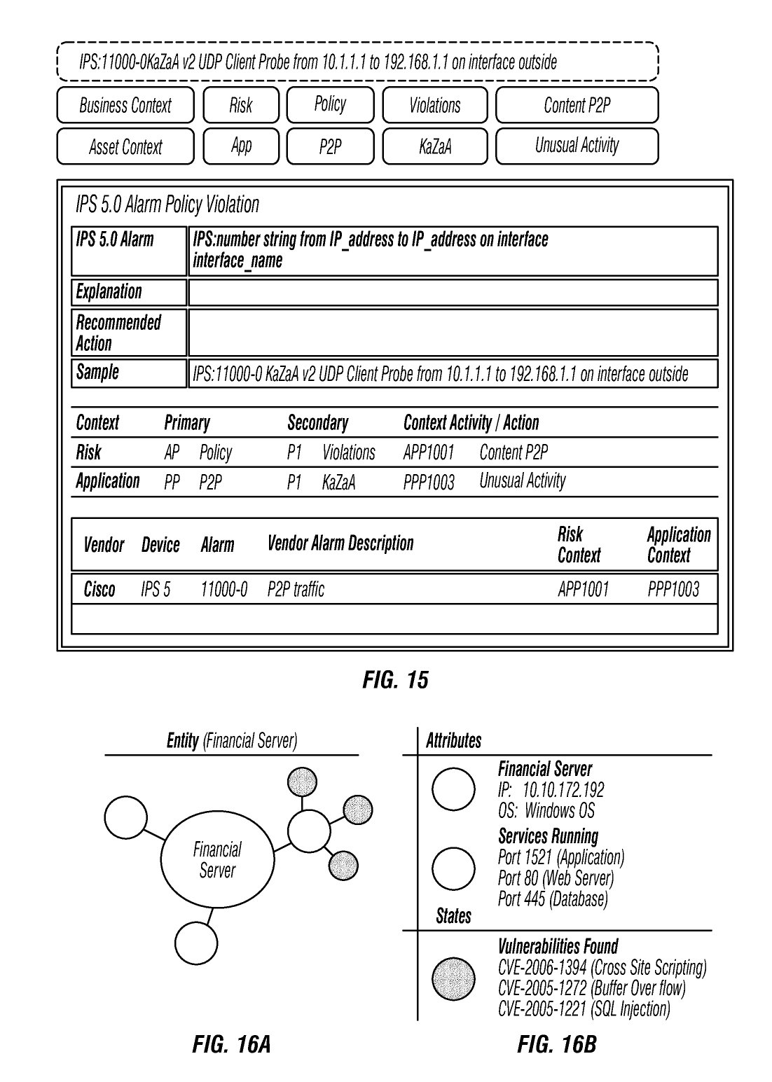

The example in FIG. 15 example shows another Cisco ASA event which shows P2P traffic on the network as per the security guidelines if the P2P traffic or Apps are banned in the organization then its violation of the policy. In this example a single event is tagged with following tags: IPS:11000-0 KaZaA v2 UDP Client Probe from 10.1.1.1 to 192.168.1.1 on interface outside

Extracting the data and mapping it into relevant business context makes every piece of information received into an intelligent knowledge base. The two main contexts (Business and Asset) have its own hierarchical structure spanning into five levels and the incoming data or event is mapped across these two hierarchical pyramids. This is a unique approach in the industry. Two hierarchical structures linked using columns horizontally and dynamically creating a column structure at run time.

This is the basic building block for the rest the Sub Risk Models. For example, Asset Profiling, Threat Profiling, Base-Lining of the network, identifying normal business traffic etc. will enable the system to understand the uniqueness of each customer infrastructure and the network/system behaviour.

FIG. 16 shows how Assets are profiled. Apart from the vulnerabilities normal traffic pattern to the Asset will also be monitored and mapped using the Business Context (Normal trafficBased on the Asset placement in the network Exposure value will be calculated along with services running and vulnerabilities found and the criticality of the exposure and vulnerabilities.

Continuous base lining and profiling of the system helps model to see change in normal behaviour and predict threats or other system constraints which can violate the compliance.

Impact rating is classified as either low, moderate, or high. Low means that it has a limited adverse effect. Degradation in mission capability to an extent or duration that primary mission effectiveness is noticeably reduced OR Minor damage to Organizational Assets OR Minor Financial Loss OR Minor harm to Individuals. Moderate is serious adverse effect. Significant degradation in mission capability to the extent or duration that organization is not able to perform one or more of primary functions OR Significant damage to Organization Assets OR Significant Financial Loss OR Significant harm to individuals that does not involve loss of life or prolonged illness which will negatively impact the business. High means Severe or Catastrophic adverse effect. Severe degradation in or loss of mission capability to an extent and duration that the organization is not able to perform one or more of its primary functions OR Critical damage to Organizational Assets OR Critical Financial Loss OR Severe or Catastrophic harm to individuals involving loss of life or serious life threatening injuries.

Compliance Analysis maps all other Analysis into a Unified Compliance framework. Example: PCI-DSS

| PCI-DSS | | Objectives |
|---|---|---|
| 1, 2 | Build and Maintain Secure Network | Process Audit Analysis |
| 3, 4 | Protect Card Holder Data | Asset Analysis |
| 5, 6 | Vulnerability Management | Vulnerability Analysis |
| 7, 8, 9 | Strong Access Control Measures | Asset Analysis |
| 10, 11 | Monitor and Test Networks | Information Monitoring |
| 12 | Maintain and Information | Process Audit Analysis |
| | Security Policy | |

| Inputs | Output |
|---|---|
| 1 Process Audit Matrix (Compliance Specific) | Compliance Matrix |
| 2 Threat Matrix (Compliance Specific) | |
| 3 Asset Matrix | (Compliance Specific) |
| 4 Vulnerability Matrix (Compliance Specific) | |

Risk Determination takes inputs from all other matrix and rating and creates a comprehensive Risk Assessment of Security, Availability, Performance and IT-GRC.

Below is the output created after the determination of the Risk. It sends information back into the system to tune the process further and take preventive measures. This makes the system a self-learning unique Risk Model.

| Inputs | Output |
|---|---|
| Risk Rating | Process Audit Refinement |
| | Preventive Measures |

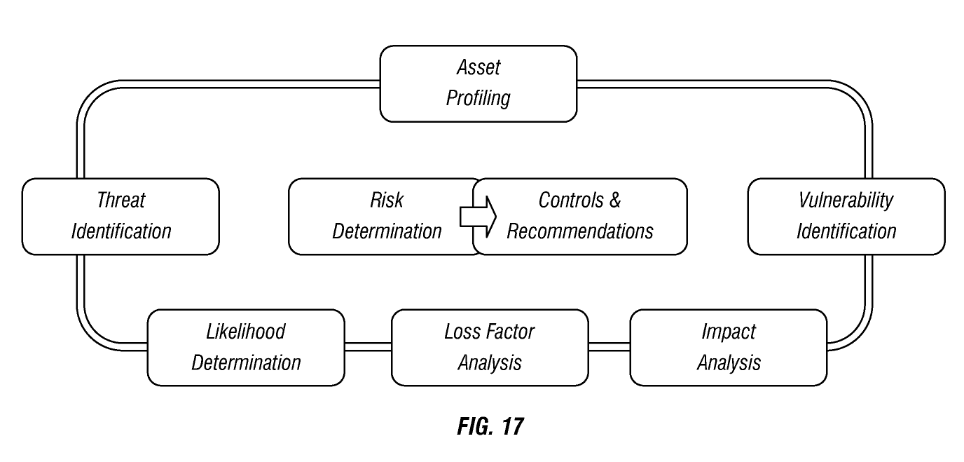

A Quantitative Risk model is shown in FIG. 17, which is much more simple compare to the Qualitative Risk Analysis. Mapping of the Risk to a dollar value (Financial) is the key aspects of the Quantitative Risk Analysis. It uses many of the algorithms already defined in the Qualitative Risk Analysis. Following diagram illustrates the process.

Loss Factor Analysis will figure out the cost involved in the likelihood of an attack in the future.

| Inputs | Outputs |
|---|---|
| Asset Matrix | Loss Factor Matrix |
| Vulnerability Matrix | |
| Likelihood Rating | |

Loss Factor Analysis determines the following: Single Loss Expectancy=Asset Value*Exposure; and Annualized Loss Expectancy=Single Loss Expectancy*Annualized Rate of Occurrence.

Other embodiments of the invention will be apparent to those skilled in the art from consideration of the specification and practice of the invention disclosed herein. It is intended that the specification and examples be considered as exemplary only, with a true scope and spirit of the invention being indicated by the appended claims.

What is claimed is:

1. A method of effective information governance and risk management, comprising:
Integrating security monitoring and compliance management application silos; and
delivering the integrated silos through a cloud based infrastructure.
